(19) United States
(12) Patent Application Publication
(10) Pub. No.: US 2013/0292193 A1
(43) Pub. Date: Nov. 7, 2013

(54) WORK BOOTH HAVING AN INTEGRATED SCALE

(71) Applicant: Sartorius Weighing Technology GmbH, Goettingen (DE)

(72) Inventors: Winfried GRAF, Niemetal (DE); Michael LAUBSTEIN, Goettingen (DE); Jan VON STEUBEN, Goettingen (DE); Thomas PERTSCH, Goettingen (DE); Dirk AHLBRECHT, Uslar (DE); Christian SCHRADER, Bodenfelde (DE)

(21) Appl. No.: 13/938,684

(22) Filed: Jul. 10, 2013

Related U.S. Application Data
(63) Continuation of application No. PCT/EP2012/000030, filed on Jan. 5, 2012.

(30) Foreign Application Priority Data
Jan. 11, 2011 (DE) 10 2011 000 085.2

(51) Int. Cl. G01G 21/28

(52) U.S. Cl. CPC G01G 21/286
USPC 177/181; 177/180

(57) ABSTRACT

A work booth (22) having a work chamber (20) and an integrated scale (10) that includes a load carrier (12) which is arranged in the work chamber (20) of the work booth (22), a weighing system (14) which is arranged outside the work chamber of the work booth (22), and a coupling element (16) which connects the load carrier (12) to the weighing system (14). The work chamber (20) of the work booth (22) has a ventilation opening (28), through which air can be extracted from the work chamber (20) of the work booth (22).

The present application is a Bypass Continuation of International Application No. PCT/EP2012/000030, filed on Jan. 5, 2012, which claims priority from German Patent Application 10 2011 000 085.2, filed on Jan. 11, 2011. The contents of these applications are hereby incorporated into the present application by reference in their respective entireties.

### FIELD AND BACKGROUND OF THE INVENTION

The invention relates to a work booth having an integrated scale, in particular an integrated precision scale.

Precision scales are used in laboratories in the chemical and pharmaceutical industries and for research, in order to weigh out small quantities of substances because, for example, a particular quantity of a sample is needed for an analytical process or because different substances are to be mixed in a pre-determined ratio. In some cases, substances are used which are toxic and in these cases, the dosing and weighing out must take place in a safety work booth, that is, a work booth provided with a ventilator or extraction system. This ensures that all particles and/or aerosols of the substances which enter the ambient air during handling are extracted in a controlled manner and are thus unable to endanger the operator.

It is currently usual to place the devices used into a universal work booth which is found generally in laboratories, depending on the dosing and analytical procedures to be carried out. If it is required, therefore, to weigh out very small quantities of a substance, a precision scale is placed in the work booth. It is herein disadvantageous that, following the weighing out, the entire device must be cleaned again, since otherwise cross-contamination with substances which are dosed in a subsequent weighing procedure cannot be precluded. However, a precision scale of this type is usually very difficult to clean completely, because components such as electronics boxes, mains components or cables with plugs do not usually have smooth surfaces.

EP 1 106 978 A2 discloses an analytical scale with a device for generating an ionized air stream in a bypass conduit of the weighing chamber.

DE 100 31 415 A1 discloses an analytical scale with a windshield which surrounds a weighing chamber. An air circulation system which is provided with a heating device is associated with the weighing chamber.

EP 2 230 494 A1 discloses a scale with a weighing chamber and an auxiliary chamber, wherein the weighing chamber and the auxiliary chamber are fluidically connected in order to form a stable air layer and/or for pressure equalization.

### OBJECTS AND SUMMARY OF THE INVENTION

It is an object of the invention to simplify, as far as possible, the necessary cleaning process following weighing out of, for example, toxic substances in a work booth. Further objects include improving the protection of products and persons and achieving optimum matching of the individual assemblies.

In order to achieve these objects, according to one formulation of the invention, a work booth is provided with a work chamber and an integrated scale having a load carrier which is arranged in the work chamber of the work booth, a weighing system which is arranged outside the work chamber of the work booth, and a coupling element which connects the load carrier to the weighing system. The work chamber of the work booth has a ventilation opening which is associated with an extractor, e.g. a suction side of a blower/filter unit, and through which air is extracted from the work chamber of the work booth.

The extraction can be adapted to the actual requirements, as needed, through regulation or control. One concept underlying the invention is that of integrating the devices of work booth and precision scale, which heretofore have been provided separately, with one another such that only the parts which are indispensable for the weighing procedure, for example, the load carrier in particular, are arranged in the work chamber. The majority of the components of the precision scale are arranged outside the work chamber of the work booth, so that the work chamber of the work booth can very easily be cleaned once a weighing procedure is completed. In addition, the protection of persons and products is improved, and the components can be functionally matched to one another to an optimum extent.

Preferably, a separating wall with a passage for the coupling element is provided between the work chamber of the work booth and the weighing system, wherein the coupling element is fed through the passage in an essentially media-tight manner. The media-tight passage ensures that, of the substances with which work is carried out in the interior of the work chamber, almost no particles/aerosols can pass through the separating wall to the weighing system, which can be cleaned only with great difficulty. The expression “essentially media-tight passage” does not mean that no media at all can be exchanged through the passage. Of decisive importance is that the substances which are used in the work chamber of the work booth cannot pass through the passage.

It is preferably provided that the separating wall coincides with the rear wall of the work chamber. In this case, a smooth-surfaced rear wall which can be particularly easily cleaned results.

According to an alternative embodiment, it is provided that the separating wall projects into the work booth. This enables the load carrier to be arranged closer to the front side of the work booth, in order to be more accessible to a user.

According to another embodiment of the invention, an opening is provided in the separating wall and that a pressure difference can be established between the work chamber of the work booth and a space in which the weighing system is arranged. With this pressure difference, when the pressure in the interior of the work booth is lower than in the space in which the weighing system is arranged, an airstream is established from the space of the weighing system to the work chamber of the work booth. An airstream of this type prevents the substances used in the work chamber from entering the space of the weighing system.

The weighing system is preferably arranged in a housing which is provided with an inlet opening for external air. In this way, a very simple design can be obtained, since the negative pressure which is created in the work chamber relative to the surroundings during active extraction (i.e. suction) can be used to create an air stream out of the housing of the weighing system and into the work chamber.

Preferably, the inlet opening is provided with a diaphragm, the opening cross-section of which can be changed. This enables the airflow from the housing of the weighing system into the work chamber to be controlled with little effort.

It is preferably provided that the inlet opening is closable. In this way, if necessary, an airflow out of the housing of the weighing system into the work booth can be prevented.

According to one embodiment, a blower is associated with the inlet opening. This enables an airflow to be established out of the housing into the work chamber, regardless of the pressure difference between the work chamber and the housing of the weighing system.

A filter is preferably associated with the inlet opening, ensuring that no dust particles or other contaminations can enter into the housing of the weighing system.

According to another embodiment of the invention, it is provided that the weighing system is arranged in a housing which is sealed against the external air. In this embodiment, an exchange of air between the work chamber and the housing of the weighing system is suppressed as far as possible, so that impurities from the work chamber are able to enter the housing of the weighing system to the least possible extent.

According to another embodiment of the invention, it is provided that the load carrier is surrounded by a windshield. In this way, a falsification of the weighing result caused by an air stream in the interior of the work chamber when an extractor (i.e. suction pump) of the work booth is activated is prevented. Furthermore, a windshield can also prevent other types of falsification of the weighing procedure, for example, through electrostatic charges or thermal radiation.

Advantageously, various other components of importance for the operational process can be introduced into the work chamber of the work booth, for example, weighing-in aids, displays and operating elements, aids for reducing static charge, disposal and cleaning equipment as well as disinfection and decontamination devices.

According to another embodiment of the invention, it is provided that the extraction device is connected with a flexible hose in order to draw particles up by suction, where necessary, and to pass them to the filter.

According to another embodiment of the invention, the airflow in the work chamber can be substantially increased when cleaning is performed.

According to another embodiment of the invention, it is provided that the work booth comprises integrated self-diagnostic functions, for example, a filter integrity test.

According to another embodiment of the invention, it is provided that the accessway to the work chamber can be closed.

According to another embodiment of the invention, possibilities for storing and conditioning samples and vessels are provided in the work chamber.

Naturally, a plurality of such work booths can be coupled together.

### Brief DESCRIPTION OF THE DRAWINGS

The invention will now be described in greater detail by reference to two exemplary embodiments which are illustrated in the attached drawings, in which:

FIG. 1 is a schematic representation of a work booth with an integrated precision scale according to a first embodiment of the invention; and

FIG. 2 is a schematic representation of a work booth with an integrated precision scale according to a second embodiment of the invention.

### DETAILED DESCRIPTION OF EXEMPLARY EMBODIMENTS

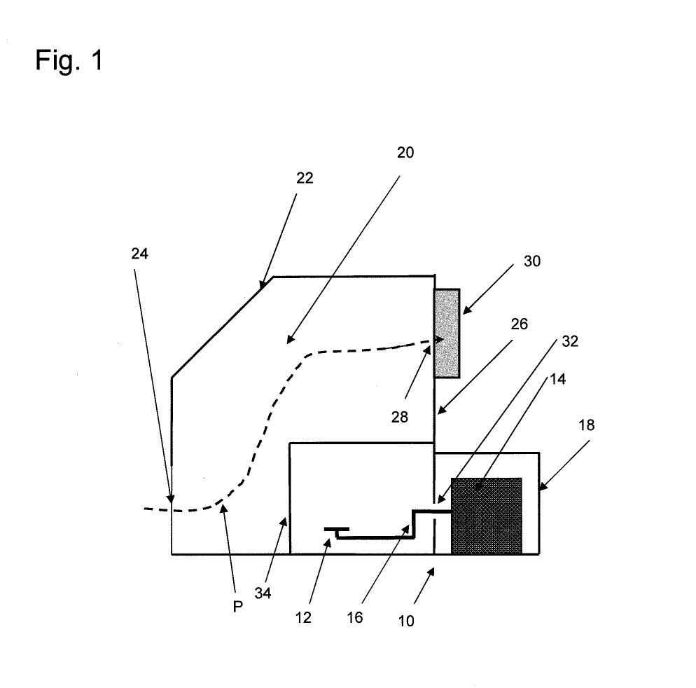

FIG. 1 shows a precision scale 10 which comprises a load carrier 12, a weighing system 14 and a coupling element 16 which connects the load carrier 12 to the weighing system 14. The weighing system 14 is arranged in a housing 18, while the load carrier 12 is situated in a work chamber 20 of a work booth 22. The work booth 22 has, at the front side thereof, an accessway 24 through which a user can gain access to the work chamber 20 of the work booth 22. Provided at a rear wall 26 of the work booth 22 is an extraction opening 28 which is associated with the suction side of a blower/filter unit 30 (hereinafter designated in general terms as an “extractor”).

The rear wall 26 is configured continuous in the vertical direction here, and is therefore also part of the housing 18 of the weighing system 14. In this region, the rear wall 26 therefore acts as a separating wall between the work chamber of the housing 18 and the work chamber 20 of the work booth 22.

Provided in the separating wall is an opening 32 through which the coupling element 16 extends from the load carrier 12 to the weighing system 14. The opening 32 is part of an essentially media-tight passage for the coupling element 16, by which substances that are used in the work chamber 20 of the work booth 22 are prevented from reaching the interior of the housing 18 of the weighing system 14. The essentially media-tight passage can be achieved through a large variety of individual measures, alone or in combination. One component of the essentially media-tight passage consists of the housing 18 of the weighing system 14 being closed to the external air. There is thus fundamentally no air exchange between the housing 18 and the work chamber 20 of the work booth 22, so that nothing of the substances used in the interior of the work booth 22 passes through the opening 32 into the housing 18. It is also an aspect of the essentially media-tight passage that the opening 32 is configured to be as small as possible.

The essentially media-tight passage can also comprise diaphragms, labyrinth seals, membranes, electrostatic filters, liquid seals or other forms which are associated with the opening 32 and with which entry of the substances used in the work booth 22 into the housing 18 of the weighing system 14 is prevented.

A user wishing to weigh out a particular quantity of one or more substances using the precision scale 10 reaches through the accessway 24 into the work chamber 20 of the work booth 22, where the substances can be handled without risk. The extractor 30 ensures that the parts of the substances which pass into the air are drawn away through the extraction opening 28 out of the work chamber 20 and cannot pass through the accessway 24 into the ambient air. The air stream generated by the extractor 30 is indicated in FIG. 1 by the arrow P. In order to prevent the airstream from falsifying the weighing procedure, a windshield 34 which is schematically indicated here, can also be provided in the work chamber 20 of the work booth 22.

When the weighing procedure is ended, the work chamber 20 of the work booth 22 must be cleaned in order to ensure that no residues of the weighed substances remain in the work booth. Said substances can be health hazards and can also contaminate other material samples that will in the future be weighed in the work booth 22. The work chamber 20 of the work booth 22 must therefore be cleaned. Complete cleaning of the work booth 22 can be performed with little effort because the work booth 22 essentially consists of planar surfaces which can be readily cleaned. In addition, the windshield 34 is preferably easily dismantled and can thus be easily removed from the work booth. Furthermore, the load carrier 12 is removable and can thus be easily cleaned outside the work booth 22. It can also be provided that the coupling element 16 can be at least partially disassembled so that as few components as possible remain within the work booth 22, needing to be cleaned therein. For cleaning purposes, the air stream through the work booth can be greatly increased in that the extractor is switched from a low operating speed that is suitable for weighing procedures, into a significantly higher operating speed.

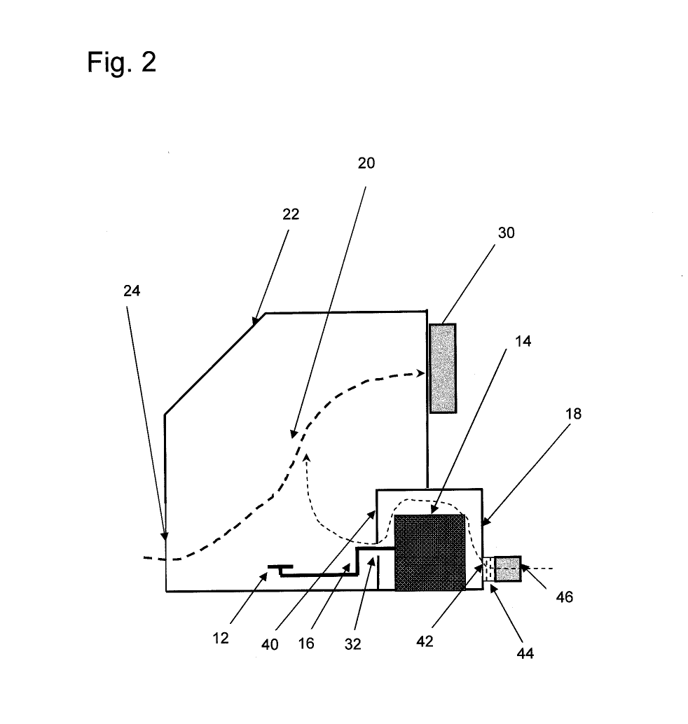

FIG. 2 shows a second embodiment. For the components already described in the context of the first embodiment, the same reference signs will be used below, and to that extent, reference is also made to the above description.

The second embodiment differs from the first embodiment with regard to the geometrical arrangement of the housing 18 of the weighing system 14 and also in that, in the second embodiment, the housing 18 is open to the surroundings so that a controlled airflow through the housing 18 can be achieved.

In the second embodiment, the rear wall of the work booth 22 does not coincide with the separating wall arranged between the interior of the housing 18 and the work chamber 20 of the work booth 22. As shown in FIG. 2, an offset separating wall 40 is provided which is arranged closer to the accessway 24 than the rear wall 26 of the work booth 22. The result is that the load carrier 12 is also arranged closer to the acces sway 24 and can therefore be more easily reached by a user. Furthermore, the step formed above the separating wall 40 on the top of the housing 18 can also be used as an additional shelf.

As distinct from the first embodiment, in the second embodiment, the housing 18 of the weighing system 14 is provided with an inlet opening 42, with which a filter 44 and a blower 46 are associated. This enables external air to be actively fed into the work chamber of the housing 18 and to be conducted away through the opening 32 into the work chamber 20 of the work booth 22. Thus, a controlled airflow out of the housing 18 in the region of the essentially media-tight passage is ensured so that the substances which are used in the work chamber 20 of the work booth 22 are unable to enter the housing 18.

The blower 46 is controllable such that the airflow through the opening 32 of the separating wall 40 can be adjusted to a desired value which is, firstly, high enough so that no substances can pass out of the work booth 22 into the housing 18 but, secondly, however is low enough so that the weighing procedure is not falsified.

As an alternative to the blower 46, a diaphragm which has, in particular, a controllable cross-section can be associated with the inlet opening 42. With this embodiment, the airflow out of the housing 18 into the work booth 22 is obtained passively, specifically due to the negative pressure which arises, relative to the ambient air, in the work booth 22 during operation of the extractor 30. The cross-section of the diaphragm can be adjusted to a value such that the desired air flow is brought about.

With regard to the risk that an airflow through the opening 32 falsifies the weighing procedure, it can be provided that the blower 46 is briefly switched off when the weighing procedure is to be carried out and that the blower is subsequently switched on again. If, in place of the blower, a controllable diaphragm is used, the diaphragm is preferably closed during the weighing procedure. In this way, the airstream out of the housing 18 into the work chamber 20 of the work booth 22 is briefly interrupted so that the weighing can be carried out. If the airflow is re-established immediately following the weighing procedure, there remains only a highly negligible risk that substances could enter the interior of the housing 18 from the work booth 22 during the brief weighing procedure.

A windshield can also be provided in conjuction with the second embodiment.

The above description of various embodiments has been given by way of example. From the disclosure given, those skilled in the art will not only understand the present invention and its attendant advantages, but will also find apparent various changes and modifications to the structures and methods disclosed. The applicant seeks to cover all such changes and modifications as fall within the scope of the invention, as originally disclosed and defined by the appended claims.

1. Work booth comprising:
a work chamber, and
an integrated scale having a load carrier which is arranged in the work chamber of the work booth, a weighing system which is arranged outside the work chamber of the work booth, and a coupling element which connects the load carrier to the weighing system, wherein the work chamber of the work booth has a ventilation opening and an associated extractor through which air is extracted from the work chamber of the work booth.

2. The work booth as claimed in claim 1, further comprising a separating wall with a passage for the coupling element between the work chamber and the weighing system, wherein the coupling element is guided through the passage in an essentially media-tight manner.

3. The work booth as claimed in claim 2, wherein the separating wall coincides with a rear wall of the work booth.

4. The work booth as claimed in claim 2, wherein the separating wall projects into the work chamber.

5. The work booth as claimed in claim 2, wherein an opening is provided in the separating wall and wherein a pressure difference is established between the work chamber and a space in which the weighing system is arranged.

6. The work booth as claimed in claim 5, wherein the weighing system is arranged in a housing which is provided with an inlet opening for external air.

7. The work booth as claimed in claim 6, wherein the inlet opening is provided with a diaphragm which has an adjustable cross-section.

8. The work booth as claimed in claim 6, wherein the inlet opening is configured to open and close.

9. The work booth as claimed in claim 6, further comprising a blower associated with the inlet opening.

10. The work booth as claimed in claim 6, further comprising a filter associated with the inlet opening.

11. The work booth as claimed in claim 1, wherein the weighing system is arranged in a housing which is closed in relation to ambient air external to the work booth.

12. The work booth as claimed in claim 1, wherein the extractor is configured to operate at a low level for a weighing procedure and at a higher level for a cleaning procedure.

13. The work booth as claimed in claim 1, wherein the load carrier is surrounded by a windshield.

14. The work booth as claimed in claim 1, wherein the work booth has an accessway configured to provide a user with access into the work booth.

15. The work booth as claimed in claim 1, further comprising an integrated dust suction unit.

16. The work booth as claimed in claim 1, further comprising a self-diagnosis unit.

17. The work booth as claimed in claim 1, further comprising a closable acces sway.

18. The work booth as claimed in claim 1, wherein the extractor comprises a blower and filter unit.

19. The work booth as claimed in claim 18, wherein the blower is configured to operate at both a relatively low suction speed for a weighing operation and a relatively high suction speed for a work chamber cleaning operation.
